(19) United States
(12) Patent Application Publication
(10) Pub. No.: US 2008/0229645 A1
(43) Pub. Date: Sep. 25, 2008

(54) System and method of protecting a pre-defined unenclosed area from mosquitoes and other biting insects

(76) Inventor: Akhil Demian Garland, Harrisville, NH (US)

Correspondence Address: DANIEL S. COOLIDGE;COOLIDGE & GRAVES PLLC, 36 OLD CHANDLERS MILLS ROAD, UNITY, NH, 03743, US

(21) Appl. No.: 11/336,372

(22) Filed: Jan. 20, 2006

(51) Int. Cl. A01M 99/00; F24F 7/007

(52) U.S. Cl. 43/1; 454/251

(57) ABSTRACT

A method of protecting a pre-defined, at least partially open area, such as a outdoor deck, patio or gazebo, from mosquitoes and other biting insects by removing the scents emitted by humans and pets that occupy the pre-defined area. The scents (Carbon Dioxide, Lactic Acid, as well as other body odors and scents) from humans and animals are either vacuumed and exhausted to an area away from the pre-defined area, or pushed out of the predefined area, thus making it difficult or impossible for a mosquito or other biting insect to identify that humans or pets are occupying the pre-defined area. This method is environmentally friendly, does not emit chemicals or poisons, and allows the occupants of the protected, pre-defined, unenclosed area to enjoy the out of doors without having to have windows, roofs, or screens obscuring airflow and the view of the landscape or heavens.

### FIELD OF THE INVENTION

This invention relates to controlling flying insects and more particularly, to a system and method for protecting a pre-defined and unenclosed area from mosquitoes and flying, biting insects.

### BACKGROUND OF THE INVENTION

Flying insects have been bothering mankind since the beginning of time. Blood sucking biting insects are well known for wrecking outdoor picnics, ruining cocktail hours and sunsets, distracting golfers, driving gardeners indoors for protection, preventing homeowners from enjoying their pool or patio, and have in fact successfully created their own season in many areas of the world, widely known as “bug season.” But beyond the many inconveniences of biting insects are perilous dangers—biting insects are responsible for over one million deaths worldwide each year. Non-biting flying insects, such as house flies, fruit flies, etc. are also an annoyance and are known to carry and transmit diseases.

While blanket, indiscriminate spraying of deadly poisons has been the method of choice for flying insect control for several decades, various contraptions have been developed over time to try and help manage flying insects (mosquitoes, black flies, gnats, horseflies, no-seeums, houseflies, etc) without the need for harmful pesticides. However none of these non-poisonous methods has been truly efficient and effective. For example electronic bug killing systems with ultraviolet light attraction sources have been proven effective at attracting and electrocuting non-biting flying insects such as moths, but have been proven ineffective at attracting and destroying biting insects.

Carbon-dioxide baited biting insect traps have been in use for decades, first as research tools and monitoring apparatuses to assist in insecticide-based mosquito control planning, and more recently commercially sold as traps that can be placed in a yard or near an area to be protected. It is well known that biting insects are attracted to Carbon Dioxide and that they navigate upwind towards a source of CO2 in search of a host. CO2 baited traps are generally operated as stand-alone traps, and while they often do catch biting insects, they are usually ineffective due to the fact that there is an overwhelming population (often hundreds of thousands) of biting insects in the vicinity to be protected and a stand-alone trap can only clear a small area down-wind of where the trap has been placed.

Scent masking agents have been developed that insert chemicals into an area to be protected with the hope of inhibiting the receptors of biting insects in a way that renders them incapable of tracking and ultimately biting humans. This method of controlling biting insects is unappealing as it not only pollutes the ambient air with chemicals but also creates unpleasant odors. It is also generally quite ineffective.

Electric fans have been used to blow on humans in an effort to distract biting insects, but the noise of the fans and the airflow can be most unpleasant.

Screened in porches have, to date, been the most effective method of preventing biting insects from entering a predefined area, but they effectively jail the human being and prevent him from enjoying the sweet outside air, restrict him from seeing clearly the beautiful out-of-doors and from enjoying the heavens above.

Yu, in U.S. Pat. No. 6,474,014, teaches of an electronic bug zapper attached to an exhaust ventilator to help protect a room inside a house, but not only is the killing of the biting insects loud, expensive and unnecessary, the system does not protect unenclosed out-door areas such as decks and porches with no windows or open windows. Protection of open areas requires a different approach and way of thinking.

### SUMMARY OF THE INVENTION

This instant invention comprises a method of protecting a pre-defined, at least partially open area, such as a outdoor deck or gazebo, from mosquitoes and other biting insects by removing the scents emitted by humans and pets that occupy the pre-defined area. The scents (Carbon Dioxide, Lactic Acid, as well as other body odors and scents) from pets and animals are vacuumed, exhausted, and re-directed to an area away from the pre-defined are, thus making it difficult or impossible for a mosquito or other biting insect to identify that humans or pets are occupying the pre-defined area. This method is environmentally friendly, non-harmful of God's creatures, does not emit chemicals or poisons, and allows the occupants of the protected, pre-defined area to enjoy the out of doors without having to have windows, roofs, or screens obscuring airflow and the view of the landscape or heavens above.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims.

### DETAILED DESCRIPTION OF THE PREFERRED EMBODIMENTS

The goal of the present invention is to protect a predefined, at least partially open area, such as a deck or gazebo or porch, from mosquitoes and other biting insects. Such a predefined space, such as a deck or porch, can be pre-existing and retrofitted and adapted to be protected, or can be built from scratch to provide an area that is free of, or relatively free of, annoying and potentially dangerous biting insects.

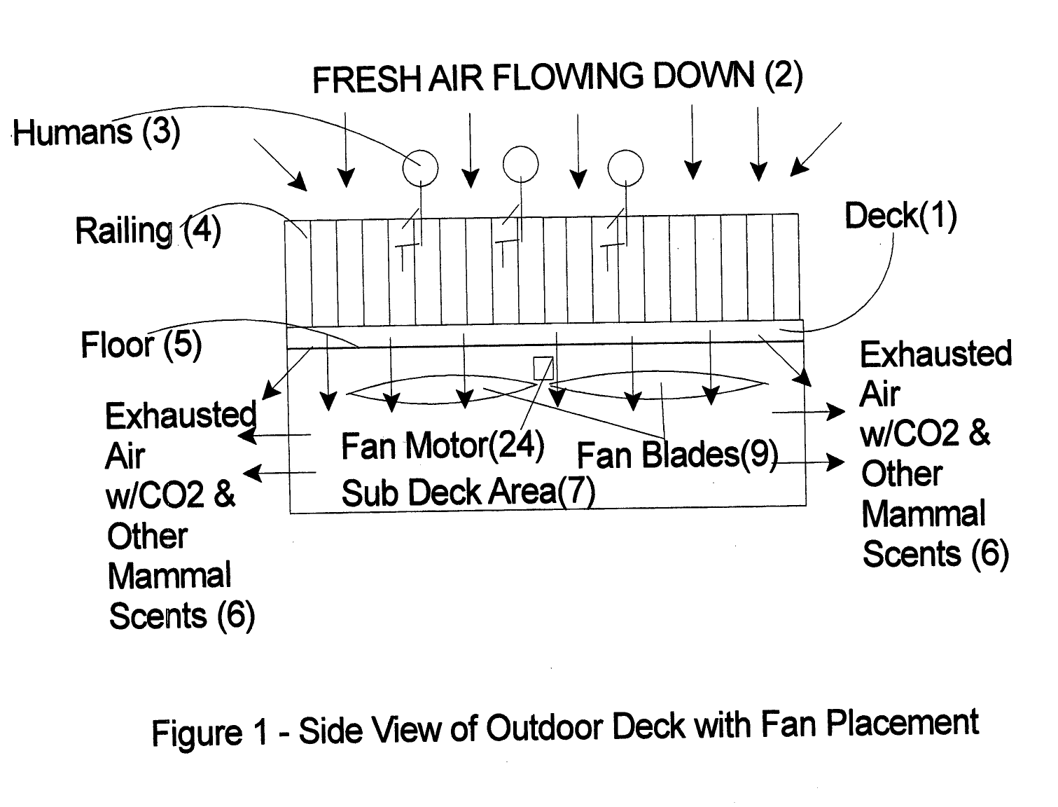

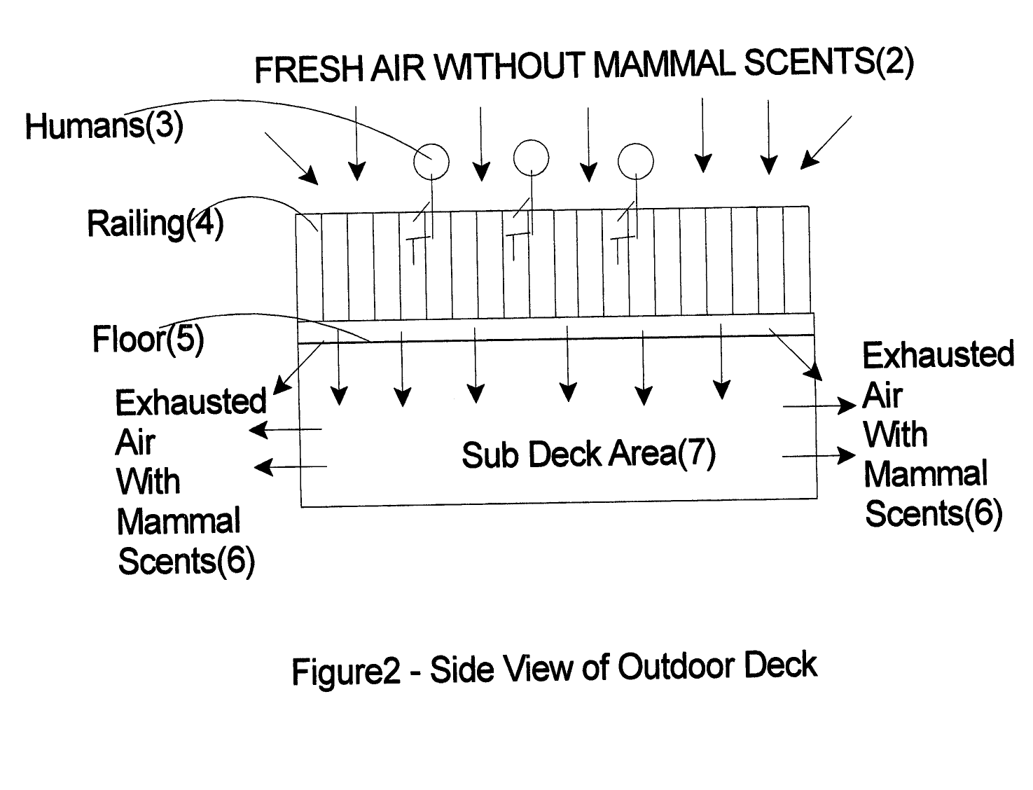

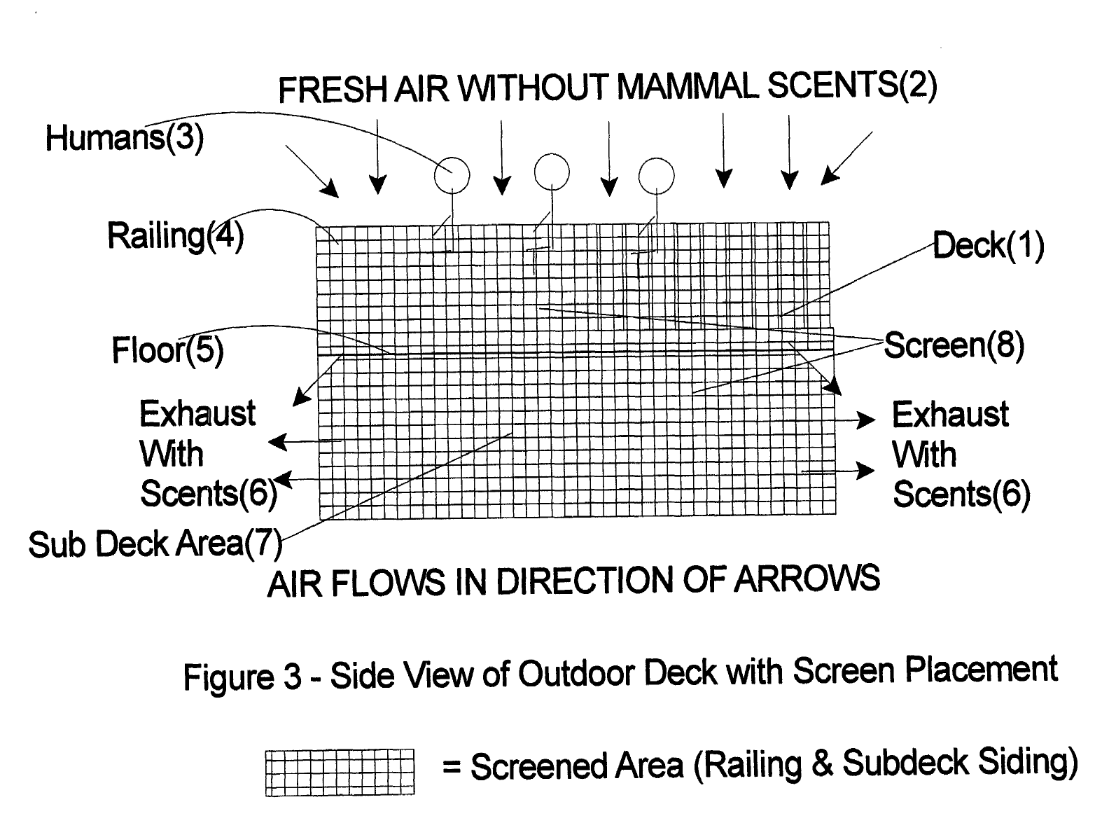

Female mosquitoes and other biting insects fly upwind, navigating towards a host in search of blood to provide protein for their eggs. They track and follow scents emitted from mammals, which include Carbon Dioxide, lactic acid, and other body scents and odors. By redirecting these scents to a different area with a barrier, such as an insect screen, the biting insects are prevented or discouraged from entering the predefined area to be protected, such as the area above a deck or within a non-enclosed porch. Using an outdoor, unenclosed deck as an example, a deck such as that in FIG. 1 (6) is constructed with a fan motor (24) and blades (9) housed beneath the floor of the deck. When activated, the fan or a plurality of fans create a vacuum and suck the air scented with human body odor and Carbon Dioxide down underneath the floor of the deck, where it is then distributed out the side or sides (also known as the skirt) of the deck. Mosquitoes and other biting insects follow the scent to the screened, lower side of the deck (1) or sub deck (7), at which point they can no longer travel up the stream of the scent and are blocked from entering the predefined area above the floor (5) of the deck. By redirecting the human and or pet scents in this way mosquitoes and other biting insects are discouraged from entering the area of the deck protected by this system, thus creating an unenclosed area above the deck that is relatively free of biting insects. Insect screening is applied along the skirt that runs around the perimeter of the deck (1), below the floor (5) of the deck (1), either on the inside of the skirt or on the outside of the skirt. For best results, screening is also applied on the outside or inside of the deck railings (4) (see FIG. 3) that run around the perimeter of the deck. In this way all of the human scents do not need to pass through the floor (5) of the deck but can instead pass through the railings (4) and the occupants of the deck (3) can still be offered protection.

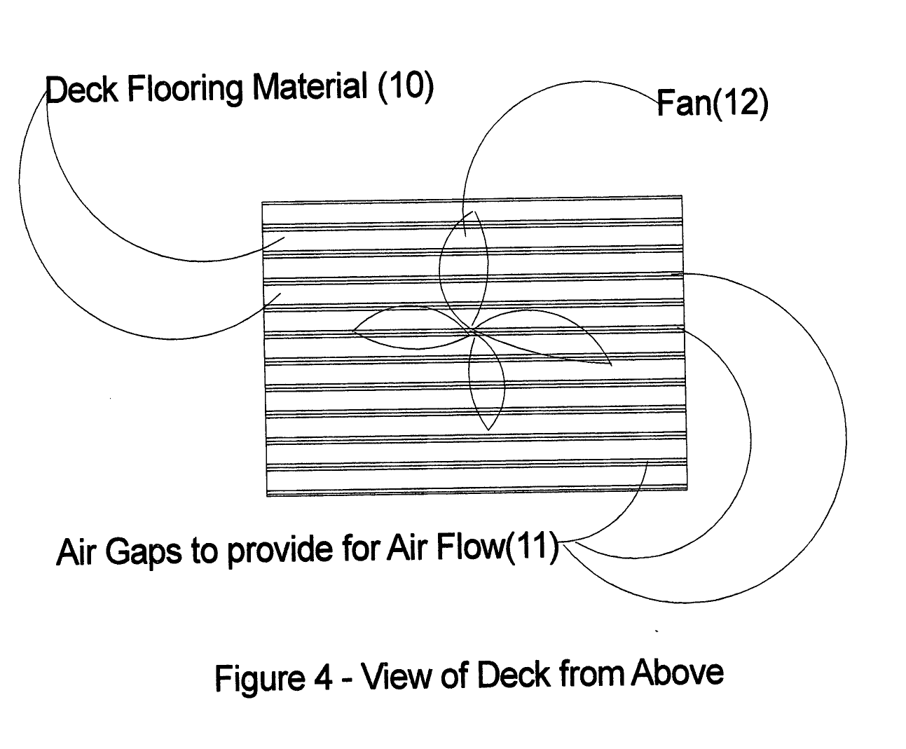

To achieve the goal of redirecting human scents from the predefined area above the deck, adequate airflow is necessary. To allow for proper airflow, open space is created in the floor of the decking to allow air to pass through the floor (FIG. 4). The deck flooring material (10) is set apart with air gaps in between (11), in such a way as to allow the air and human scents to be redirected or pulled down through the floor. The deck flooring could be made of wood, recycled materials, or even metal, so long as holes or channels are provided for adequate air flow. The fan (12) or a plurality of fans (12) operate at a variable speed, so the optimum airflow can be achieved in a way so the fans are not too loud and the airflow is not too great, so mosquitoes and other biting insects will gather at the insect screening barrier (8) In the instance where a door is needed on the deck, for example to exit the deck onto a lawn, a screened door of similar height as that of the deck railing (4) can provide protection from the biting insects.

Although the fans 12 or fan motors 24 are shown or talked about as electric fans, the present invention contemplates fans 12 which are direct wind driven, with no motors, and also electrically operated fans that are solar or battery powered.

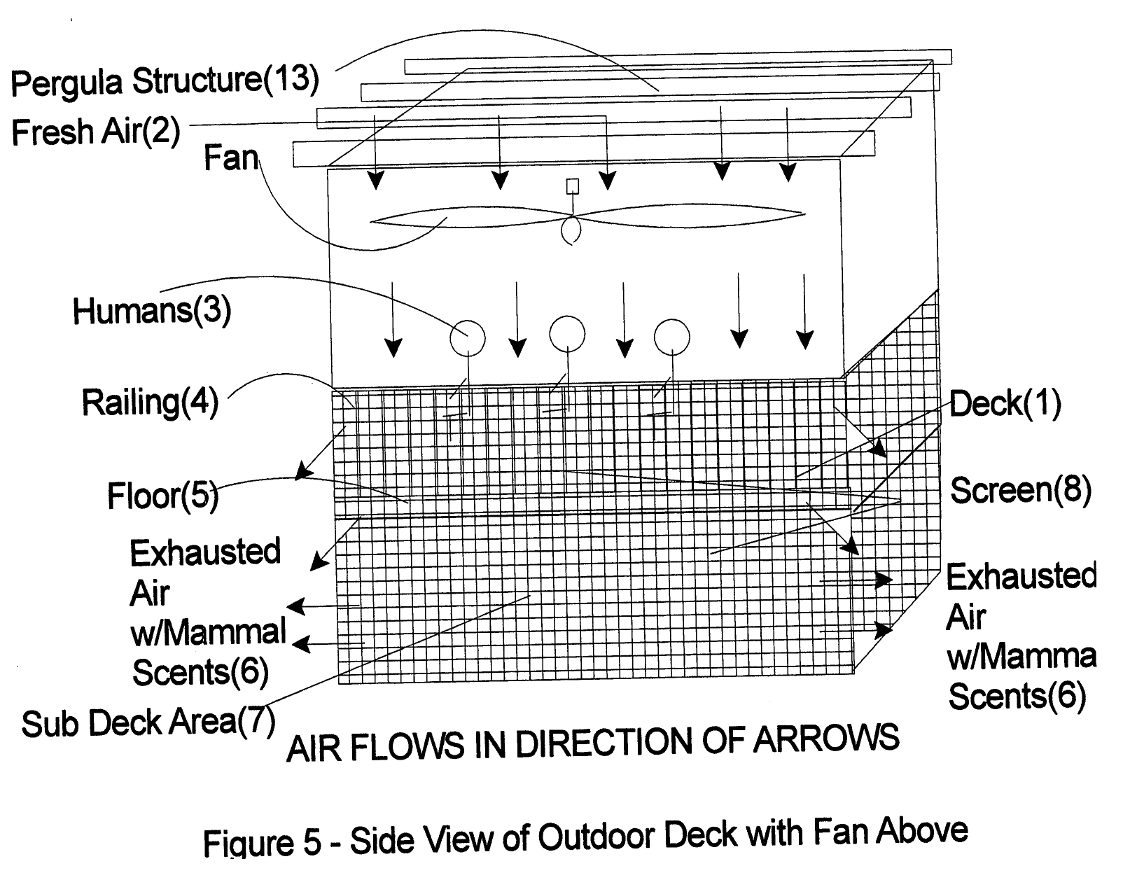

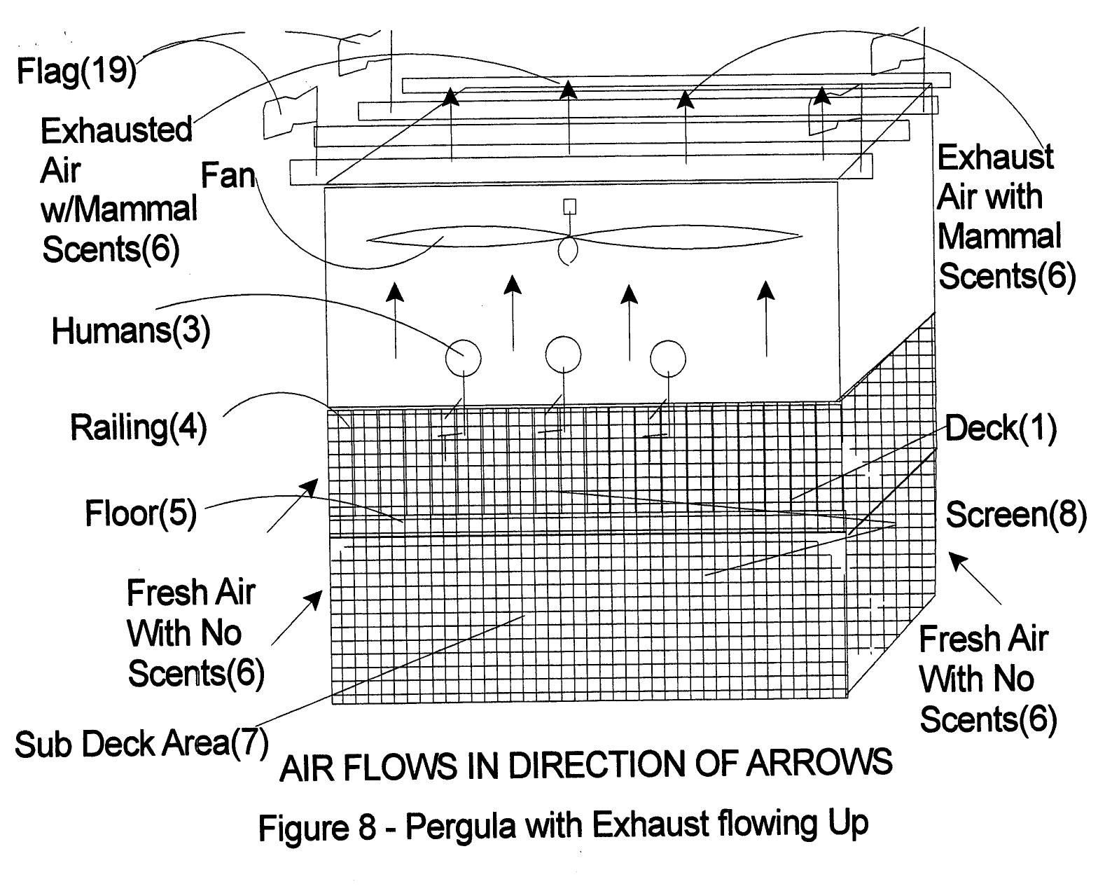

In another configuration, that of a deck with an open pergula structure (13) above (see FIG. 5), the fan (12) or a plurality of fans (12) can be mounted above the deck, on the ceiling or the underside of the pergula, blowing fresh air (2) down and redirecting the body scents of the humans or deck occupants (3) below the deck or through the screened railings (4). In this configuration, the exhausted air with mammal scents exits either out the screened sub deck area (7) or the screened railing (4). A pergula here is defined as an unenclosed structure, such as that with beams or boards running along the top of the structure but with open air between the boards or beams (see FIG. 8).

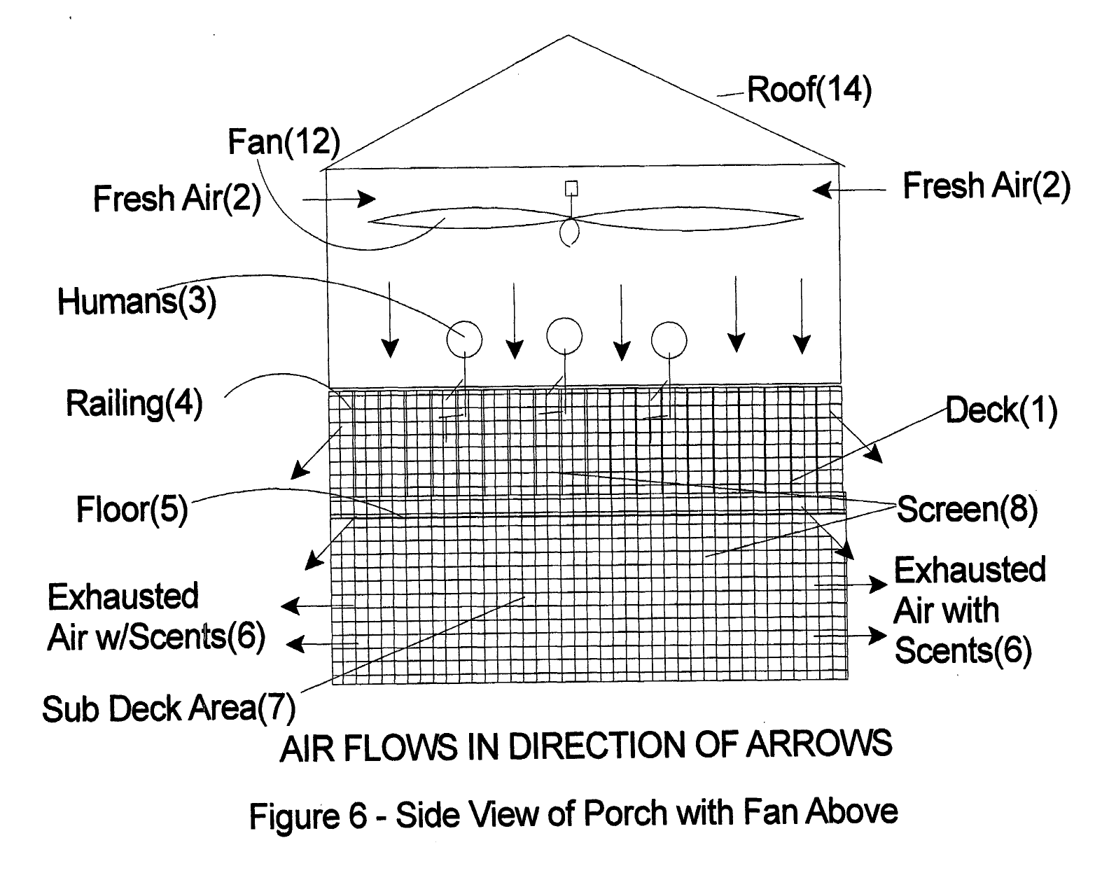

In yet another configuration (see FIG. 6), a porch can be built or an existing porch can be modified in such a manner as to provide its occupants (3) with protection from mosquitoes and biting insects. In this configuration, fresh air (2) is sucked in by a ceiling-mounted fan (12) and blown down towards the floor of the deck(S). The human scents are redirected and blown either down through the floor of the deck and out the screened skirt of the deck or down and out the screened railing (4) of the deck.

In yet another configuration (see FIG. 8), a fan (12) is attached to a pergula structure above the deck but, unlike the pergula description above, the human scented air (6) is blown up instead of down. The exhausted air with human or mammal scents (6) rises above the top of the pergula, attracting biting insects to the area above the pergula instead of the area below where occupants (3) of the deck are sitting. This technique is especially effective on black flies, as they tend to swarm the highest object in the vicinity. With the attractant of the mammal scents (6) present above the pergula, the black flies and other biting insects will be in an excited, blood-seeking state, and will be especially attracted to moving objects. By placing a dark colored flag, a dark colored rotating sail, a dark colored balloon, almost any dark colored mechanical moving object, or other similar object projecting above the pergula the black flies or other biting insects will swarm above and be discouraged from bothering the occupants (3) of the deck below.

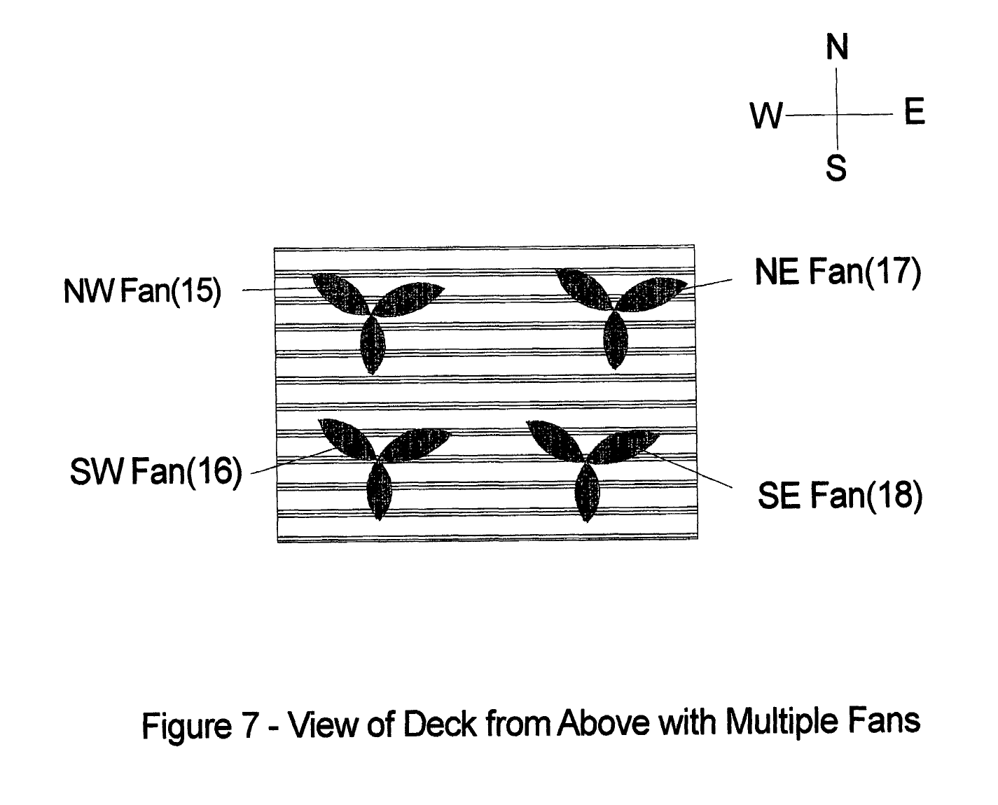

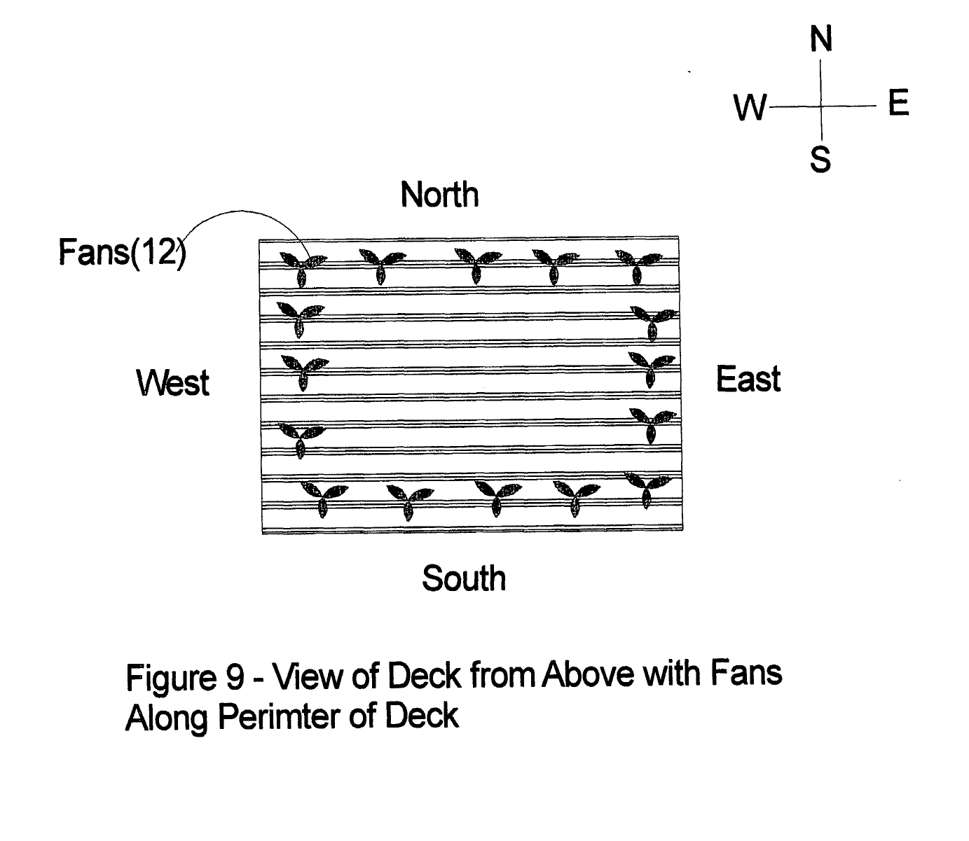

At times when wind is present the airflow on the deck will behave differently, and the needs for redirecting the human scented airflow will change. It is contemplated that several fans could be placed either above the deck, on the side of the deck, or below the deck (see FIGS. 7 and 9), and, depending on a variety of environmental conditions such as windspeed or wind direction, selected fans could be individually activated, or activated as groups or zones, at variable speeds to compensate for the wind and provide adequate redirection of the human scents (6) to the screened in railing (4) or screened sub-deck or skirt area (7). In this embodiment, the invention contemplates a fan controller (25) which receives weather data input (26), controls relays (27) coupled to each of the fans, which serves to individually control the operation, speed, etc, of each fan in response to one or more environmental conditions such as wind speed and direction.

FIG. 9 shows a fan configuration where fans (12) are installed along the perimeter of the deck, and fans may be activated individually or as groups or zones, depending on windspeed, wind direction, or other environmental variables. A microcontroller could be provided which would control fan activations.

In one embodiment the fan controller (25) receives the read the wind speed and wind direction as weather input (26), computes which fans are upwind or downwind of the area to be protected, and activates either the upwind fans, the downwind fans, or both. For example, if the wind or breeze were coming from the North, then the fan controller (25) could activate a fan or a group of fans situated on the North side of the area to be protected, or activate the fans on the South side of the area to be protected, or possibly activate both the Northern fans and the Southern fans.

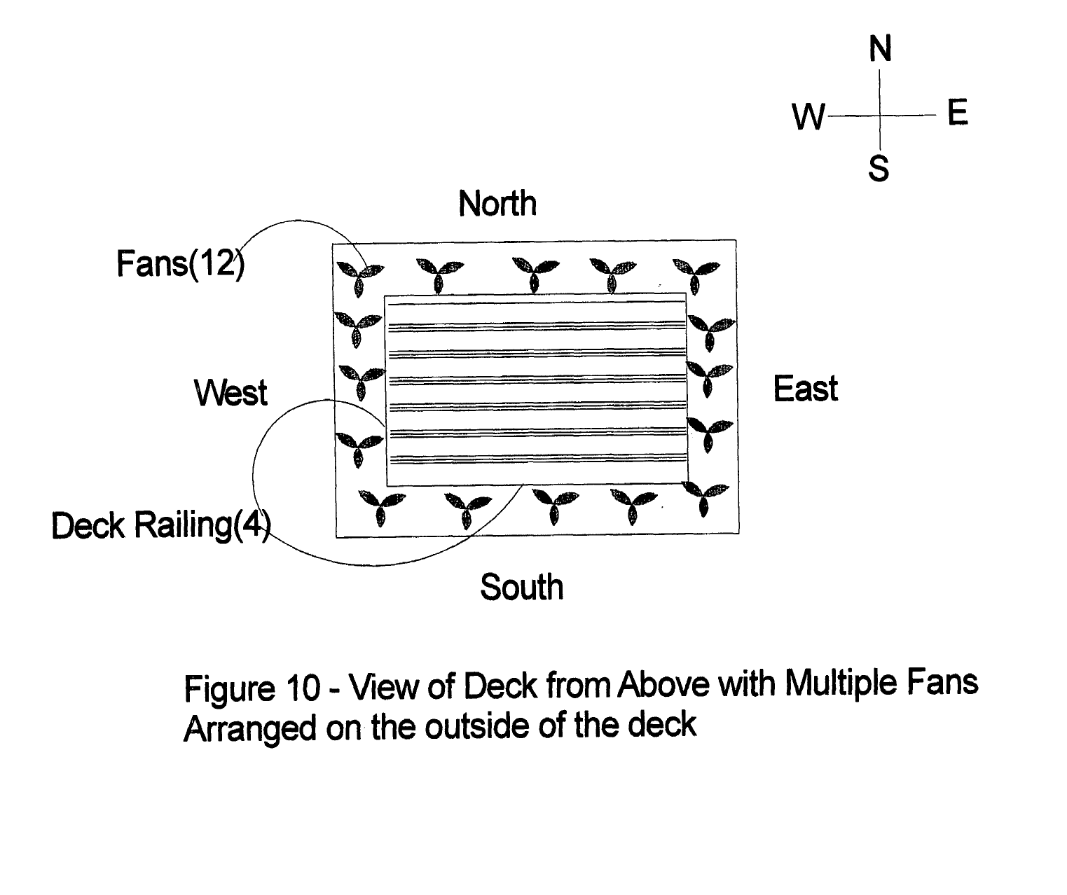

FIG. 10 shows a configuration where the fans (12) are installed along the outside of the deck, which has the advantage of not needing to install fans under the deck. In this case fans may be activated individually or as groups or zones, depending on windspeed, wind direction, or other environmental variables. A microcontroller could also be provided which would control fan activations.

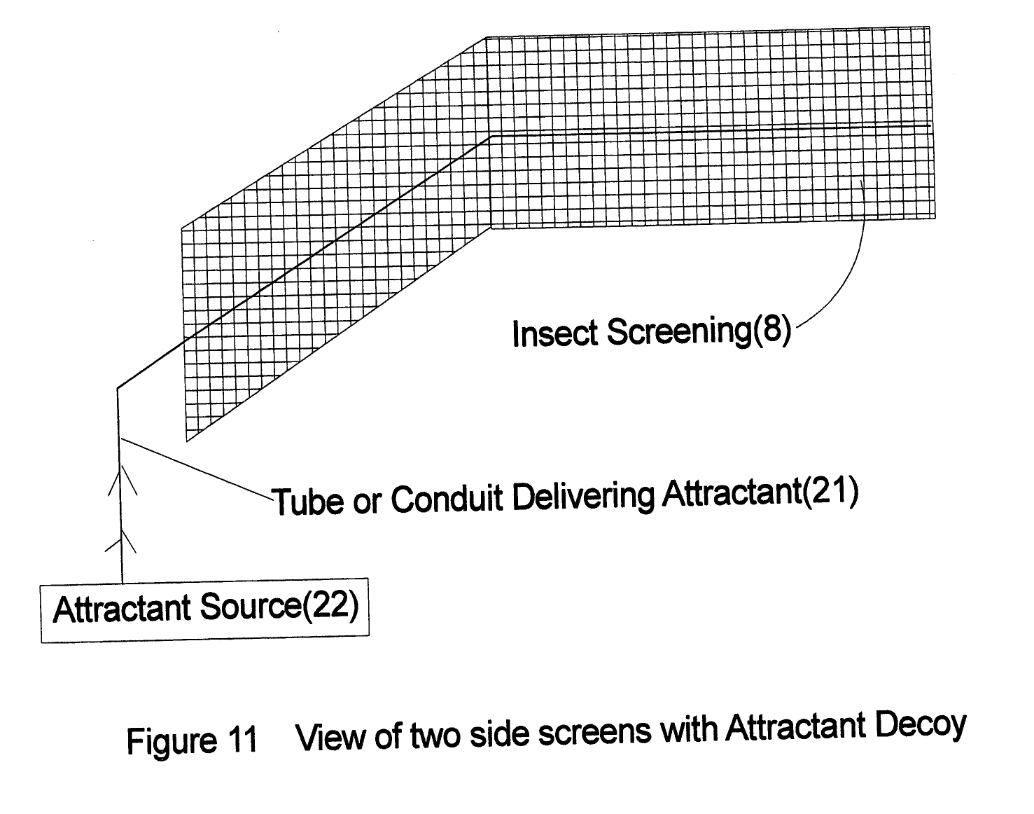

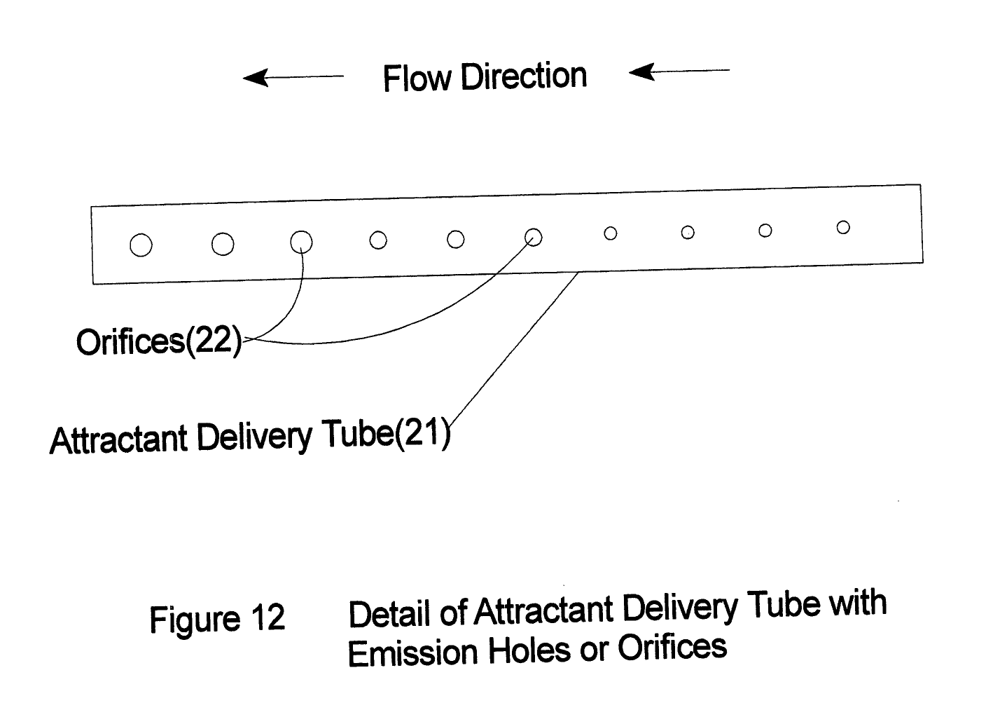

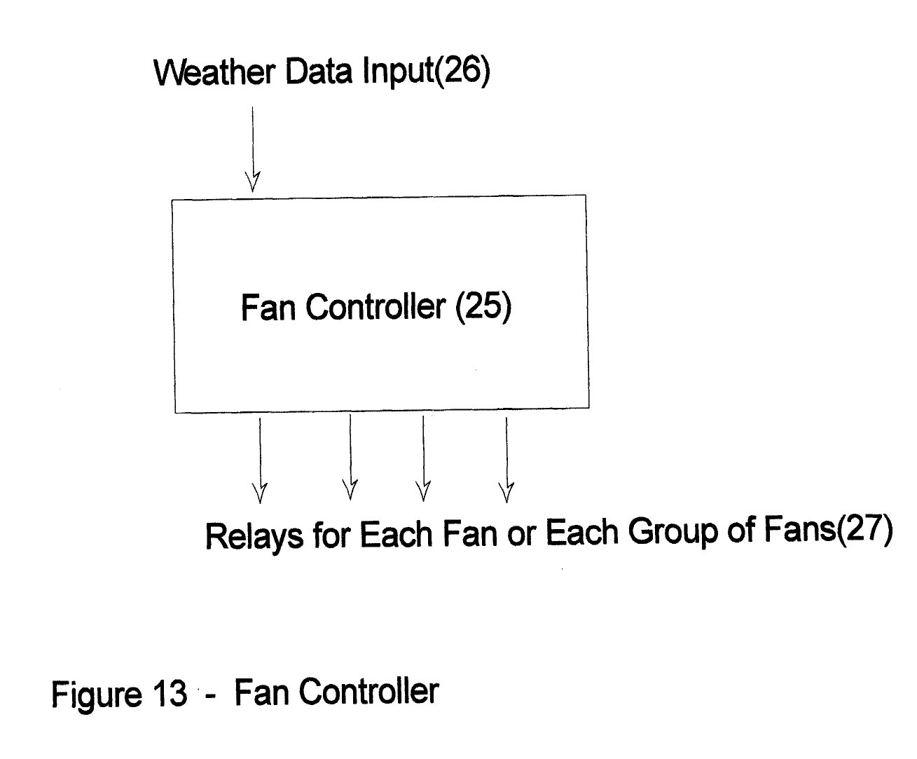

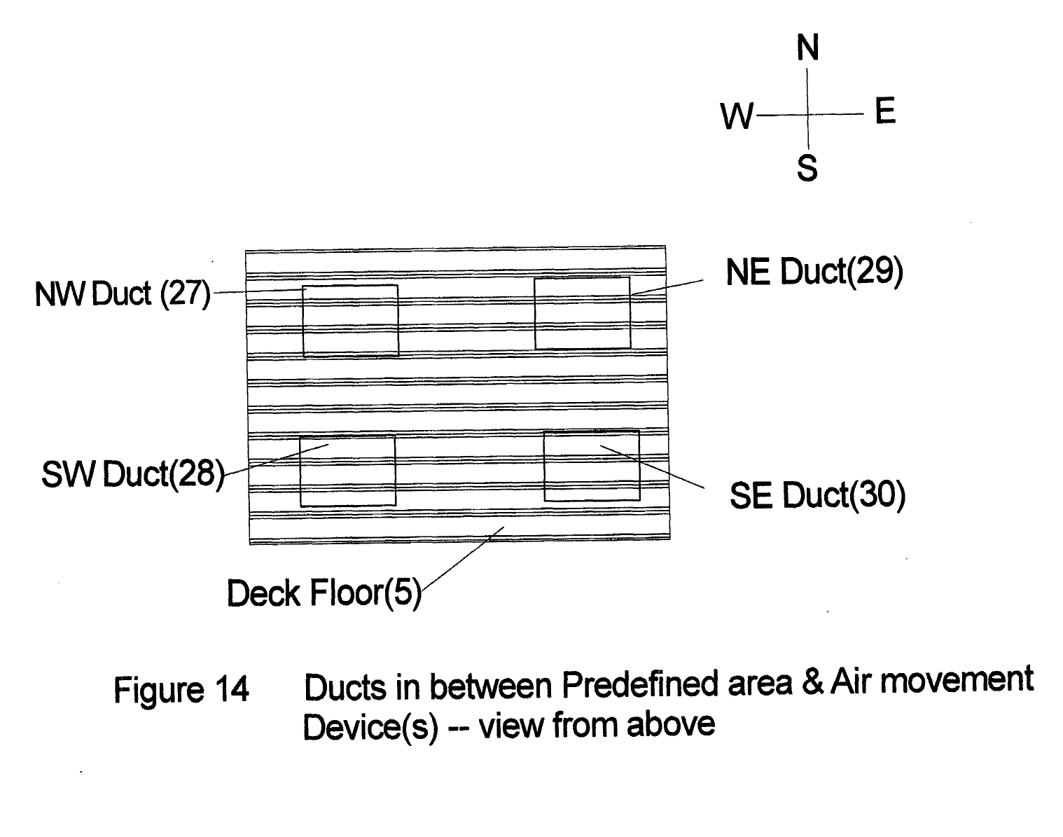

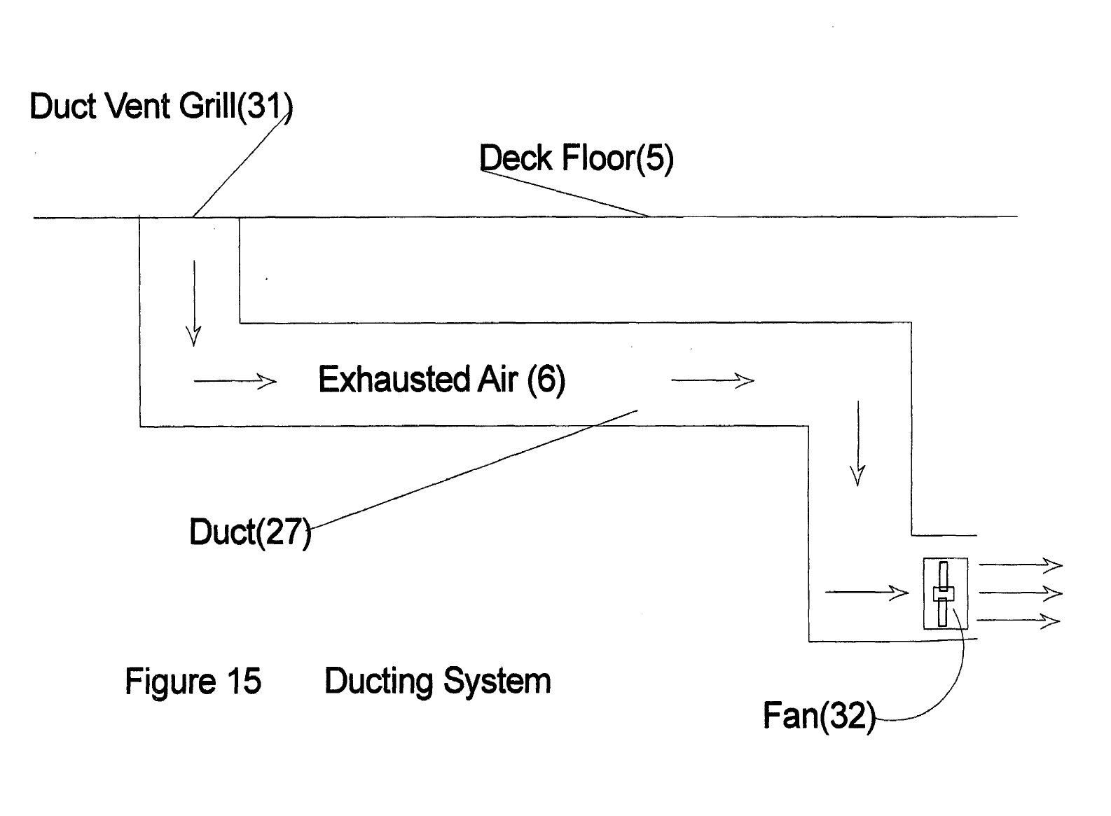

A further improvement on this system (see FIG. 11) includes the disbursement of additional attractants, such as CO2, Lactic Acid, or other attractants that are disbursed from an attractant source (22), such as a tank of CO2, a CO2 Generator (such as one that burns a carbon based fuel (such as liquid propane or natural gas) to generate Carbon Dioxide). These attractants are delivered through a delivery mechanism such as a tube or conduit (21) and dispersed through orifices (22) (see FIG. 12) along the side screens that extend around the predefined area to be protected. Mosquitoes and other biting insects are attracted to the non-mammal generated attractant and therefore do not tend to fly above the insect screening (9). As with the fans, multiple zones of tubing can be created so that only certain areas of the perimeter are activated to release attractants at a time, depending on windspeed, wind direction, or other environmental variables.

The orifices (22) in the delivery tubing are graduated in size to compensate for pressure loss within the tubing as the attractant flows down the tubing (see FIG. 12 for detailed drawing). Orifices start larger and diminish in size as the delivery distance increases.

It is contemplated that, instead of fans removing scents directly, a vent or duct (27) or a plurality of vents or ducts could be installed to vent the exhausted scented air (6) to a much more remote location, such as the other side of a house, so long as the airflow within the vent is such that biting insects cannot successfully fly up wind within the vent to reach the deck or predefined area to be protected. In this method, a more remotely located fan (32) draws air through the vent or duct, likely through a duct vent grill (31) situated proximate the deck floor (5). This improvement has the advantage of reducing the fan noise perceived from within the predefined area by moving the fan noise away from said area.

As mentioned above, the present invention is not intended to be limited to a system or method which must satisfy one or more of any stated or implied object or feature of the invention and should not be limited to the preferred, exemplary, or primary embodiment(s) described herein. Modifications and substitutions by one of ordinary skill in the art are considered to be within the scope of the present invention, which is not to be limited except by the following allowed claims and their legal equivalents.

1-32. (canceled)

32. A method of reducing airborne insect attractants comprising the acts of providing at least a partially open pre-defined area; and providing at least one air movement device, using said at least one air movement device to direct air from said predefined area thereby operable to remove at least a portion of airborne insect attractant in the region of said predefined area

33. The method of claim 32 wherein said predefined area comprises a floor region, and said airborne insect attractant is directed away from an area proximate said floor region of said predefined area by said at least one air movement device.

34. The method of claim 32 wherein said pre-defined area further comprises an upper region, and said airborne insect attractant is directed away from said upper region of said pre-defined area by said at least one air movement device.

35. The method of claim 32 wherein said predefined area includes at least one vertical barrier.

36. The method of claim 35 wherein said vertical barrier is comprised of a generally impermeable material

37. The method of claim 35 wherein said vertical barrier is at least twenty four inches high.

38. The method of claim 35 wherein said barrier comprises at least one selected from the group consisting of screen and netting.

39. The method of claim 32 further comprising at least one air movement device controller, operable to control at least one of said at least one air movement device, and further comprising at least one sensing device selected from the group consisting of a wind speed sensor, temperature sensor, humidity sensor, rainfall sensor and a wind direction sensor, and using said at least one controller to selectively activate at least one of said at least one air movement devices responsive to said at least one sensing device.

40. The method of claim 32 further comprising a defined ducted air pathway, and directing at least a portion of the airflow from said at least one air movement device through said defined ducted air pathway.

41. The method of claim 32 wherein said predefined area further comprises at least one air-permeable floor region wherein at least a portion of air directed by said air movement device is directed through said at least one air-permeable region of said floor.

42. The method of claim 41 wherein said air-permeable floor region comprises an interior area and an exterior area, and said exterior area is more air permeable than said interior area.

43. The method of claim 32 wherein said at least one air movement device further comprises at least one variable speed controller.

44. The method of claim 32 further comprising at least one timer and controlling at least one of said at least one air movement device by said at least one timer.

45. The method of claim 32 further providing insect attractant and further injecting said insect attractant into the air stream of at least one of said at least one air movement devices.

46. A system for reducing airborne insect attractants comprising at least a partially open pre-defined area; and further comprising at least one air movement device, said at least one air movement device disposed so as to direct air from said predefined area thereby operable to remove at least a portion of airborne insect attractant in the region of said predefined area

47. The system of claim 46 wherein said predefined area comprises a floor region, and said at least one air movement device is disposed so as to direct airborne insect attractant away from an area proximate said floor region of said predefined area by said at least one air movement device.

48. The system of claim 46 wherein said pre-defined area further comprises an upper region, and said at least one air movement device is disposed so as to move airborne insect attractant away from said upper region of said pre-defined area.

49. The system of claim 46 wherein said predefined area comprises at least one vertical barrier.

50. The system of claim 49 wherein said vertical barrier is comprised of a generally impermeable material

51. The system of claim 49 wherein said vertical barrier is at least twenty four inches high.

52. The system of claim 46 wherein said barrier comprises at least one selected from the group consisting of screen and netting.

53. The system of claim 46 further comprising at least one air movement device controller, connected to and operable to control at least one of said at least one air movement device, and further comprising at least one sensing device selected from the group consisting of a wind speed sensor, temperature sensor, humidity sensor, rainfall sensor and a wind direction sensor, said at least one sensor connected to said at least one controller and operable for selectively activating at least one of said at least one air movement devices responsive to said at least one sensing device.

54. The system of claim 46 further comprising at least one ducted air pathway and further disposing said at least one air movement device so as to direct at least a portion of the airflow from said at least one air movement device through said defined ducted air pathway.

55. The system of claim 46 wherein said predefined area further comprises at least one air-permeable floor region, and further disposing said at least one air movement device so as to direct at least a portion of the airflow from said at least one air movement device through said at least one air-permeable region of said floor.

56. The system of claim 55 wherein said air-permeable floor region comprises an interior area and an exterior area, and said exterior area is more air permeable than said interior area.

57. The system of claim 46 further comprising at least one variable speed controller, said at least one variable speed controller connected to and operable for controlling the speed of said at least one air movement device.

58. The system of claim 46 further comprising at least one timer, said at least one timer connected to and operable for controlling said at least one air movement device.

59. The system of claim 46 further comprising an insect attractant at least one insect attractant dispenser, said insect attractant dispenser disposed so as to inject insect attractant into the said the air stream of at least one of said at least one air movement devices.

60. A device to move airborne insect attractants away from a pre-defined at least partially open area, said device comprising at least one air movement device, said pre-defined area further comprising a semi-permeable floor region, said at least one air movement device operable for moving air from said predefined area through said semi-permeable floor region thereby removing at least a portion of airborne insect attractant from said predefined area.
